(19) United States
(12) Patent Application Publication
(10) Pub. No.: US 2022/0188286 A1
(43) Pub. Date: Jun. 16, 2022

(54) Data Catalog Providing Method and System for Providing Recommendation Information Using Artificial Intelligence Recommendation Model

(71) Applicant: DataStreams Corp., Seoul (KR)

(72) Inventors: Philip Wootaek Shin, Seoul (KR); Hyun Joo Ahn, Seoul (KR); Seongmin Park, Seoul (KR); Jinhee Lee, Seoul (KR); Seung Ho Hwang, Seoul (KR)

(73) Assignee: DataStreams Corp., Seoul (KR)

(21) Appl. No.: 17/384,869

(22) Filed: Jul. 26, 2021

(30) Foreign Application Priority Data
Dec. 14, 2020 (KR) 10-2020-0174053

(51) Int. Cl. G06F 16/23; G06F 16/2457; G06F 16/22; G06F 11/34; G06N 3/04; G06N 5/04; G06K 9/62

(52) U.S. Cl. CPC G06F 16/2358; G06F 16/24578; G06F 16/2237; G06K 9/6262; G06N 3/04; G06N 5/04; G06F 11/3438

(57) ABSTRACT

A data catalog providing method configured to provide functions related to management and retrieval for data sets stored in a database is provided. The data catalog providing method provides recommendation information for a user by collecting log data of users querying a data set by using a data catalog, and using AI (Artificial Intelligence) recommendation model, based on log data and/or data sets. The AI recommendation model, which is learned based on the collected log data, generates recommendation information by using different recommendation algorithms according to an amount of the accumulated log data.

### CROSS REFERENCE TO RELATED APPLICATION

This application claims the priority benefit of Korean Patent Application No. 10-2020-0174053, filed on Dec. 14, 2020, in the Korean Intellectual Property Office, the disclosure of which is incorporated herein by reference.

### BACKGROUND

### 1. Technical Field

The following description relates to a data catalog providing method configured to provide functions related to management and retrieval of data sets stored in a database, and a method for providing recommendation information for a user using the data catalog by using an AI (Artificial Intelligence) recommendation model.

### 2. Description of Related Art

As the fourth industry becomes active and there is a growing interest in this, various kinds of data are being generated on a large scale in various industries and fields such as IT, financial, economic, and medical, etc., and the importance of data economics which are new ecosystems via these data has been highlighted.

To asset voluminous big data, a data exchange for distributing and trading target data (original/processing data) may be constructed and utilized. Such data exchange is a platform for trading and distributing data, a user may query (i.e., retrieve, use, view, and/or download) desired data through the data exchange.

In providing data trade and distribution platforms, including such data exchange, there is an increasing need for technologies to support more efficient retrieval, share and distribution of data assets.

Meanwhile, Korean Patent Publication No. 10-2014-0133383 (Publication date: Nov. 19, 2014) discloses, as a data management apparatus, data management method and data management system, a technology for encrypting and storing data and keywords in an external storage space under a cloud environment, generating cryptographs which may be retrieved for keywords, and enabling retrieval of data including a corresponding keyword from the encrypted keywords by using a token for the keyword to be retrieved.

The information described above is merely for ease of understanding and may include contents that does not form part of the prior art.

### SUMMARY

A data catalog providing method configured to provide functions related to management and retrieval of data sets stored in a database may be provided.

As a method for providing recommendation information through a data catalog, recommendation information for a user may be provided by collecting log data of users querying a data set by using a data catalog and using an AI (Artificial Intelligence) recommendation model, based on log data and/or data sets.

Through an AI recommendation model learned based on the collected log data, recommendation information may be generated and provided by using different recommendation algorithm according to an amount of the accumulated log data.

According to one aspect of at least one example embodiment, it may provide a data catalog providing method performed by a computer system, the data catalog is configured to provide functions related to management and retrieval of data sets stored in a database, the method includes collecting log data of users who query at least some of the data sets by using the data catalog, and providing recommendation information for the users who query at least some of the data sets by using the data catalog through an AI (Artificial Intelligence) recommendation model, based on the log data and the data sets, and the AI recommendation model is learned based on the collected log data, and generates the recommendation information by using different recommendation algorithms according to an amount of the accumulated collected log data.

The recommendation information may include information about a different data set that another user who queries the data set queried by the user queries by using the data catalog, as information for the data set different from the data set queried by the user of the data sets.

The collecting the log data may include collecting log data corresponding to each item of a plurality of items as log data of the user, and generating learning data for learning the AI recommendation model by processing the collected log data corresponding to each data, and the plurality of items includes at least two of a first item representing a user ID of the user, a second item representing a user group in which the user is included, a third item representing a group of the data set queried by the user, a fourth item representing attribute or description of the data set queried by the user, a fifth item representing invoice information generated as the user queries the data set, a sixth item representing time when the invoice information is generated, a seventh item representing a code corresponding to the data set queried by the user, and an eighth item representing a registrant registering the data set queried by the user, the AI recommendation model is learned based on the learning data, the collecting the log data further includes requesting input of log data corresponding to a certain item to the user when log data corresponding to the certain item of the plurality of items cannot be collected.

The providing the recommendation information may include generating first recommendation information by using a first recommendation algorithm when an amount of the collected log data is less than or equal to a predetermined amount, and generating second recommendation information by using a second recommendation algorithm different from the first recommendation algorithm when the amount of the collected log data exceeds the predetermined amount.

The first recommendation algorithm may include a recommendation algorithm using a K prototype algorithm, the generating the first recommendation information, by applying the K prototype algorithm, includes clustering the data sets into a plurality of clusters by using a categorical variable, and determining data sets included in the first recommendation information, based on data sets included in a cluster with the highest relevance to the user of the plurality of clusters, and the categorical variable is at least one of a variable representing a group in which the user is included and a variable representing a group in which the data set queried by the user is included.

The determining may determine that a predetermined number of data sets having a higher frequency of query through the data catalog of the data sets included in the cluster with the highest relevance to the user are included in the first recommendation information, or determine that a predetermined number of data sets queried in the past by users having a higher frequency of query the data sets included in the cluster with the highest relevance to the users are included in the first recommendation information.

The second recommendation algorithm may include a recommendation algorithm using a CF (Collaborative Filtering) algorithm, the generating the second recommendation information, by applying the CF algorithm, includes comparing a first data matrix corresponding to data sets queried by the user and a second data matrix corresponding to data sets queried by at least one other user, and determining a data set to be recommended to the user as a data set included in the second recommendation information, based on a result of the comparison, and the data set queried in the past by the user is excluded from the recommendation through the second recommendation information.

The other user may be a similar user for the user determined based on a rating vector for dividing users using the data catalog into a predetermined rating.

The data sets included in the second data matrix may be data sets determined to be similar to data sets queried by the user, based on an evaluation vector representing an evaluation for data sets obtained from users using the data catalog.

The second recommendation algorithm further may include a recommendation algorithm using a DNN (Deep Neural Network) algorithm, the generating the second recommendation information includes, by applying the DNN algorithm, determining a data set to be recommended to the user of data sets stored in the database as a data set included in the second recommendation information, based on time information and a behavior pattern of the user, and the second recommendation information includes at least one data set determined based on the DNN algorithm and at least on data set determined based on the CF algorithm as a recommendation data set for the user.

Through example embodiments, in providing a data catalog configured to provide functions related to management and retrieval of data sets, proper recommendation information may be provided for a user querying (retrieving, using, viewing and/or downloading) a data set by using a data catalog.

An AI recommendation model providing recommendation information may generate recommendation information for a user by using different recommendation algorithms according to an amount of accumulated log data related to users using the data catalog.

For a user using a data catalog, as recommendation information based on time information and a behavior pattern of a user may be provided, convenience in retrieval and management of a data set through the data catalog may be enhanced.

### BRIEF DESCRIPTION OF THE DRAWINGS

These and/or other aspects, features, and advantages of the disclosure will become apparent and more readily appreciated from the following description of embodiments, taken in conjunction with the accompanying drawings of which:

FIG. 1 illustrates a method for providing recommendation information for a user using a data catalog by using an AI recommendation model, according to an example embodiment;

FIG. 2 illustrates a computer system for providing a data catalog for providing recommendation information by using an AI recommendation model, according to an example embodiment;

FIG. 3 is a flowchart illustrating a data catalog providing method for providing recommendation information by using an AI recommendation model, according to an example embodiment;

FIG. 4 illustrates a method for providing recommendation information by using a recommendation algorithm including a K prototype algorithm, according to an example embodiment;

FIG. 5 illustrates a method for providing recommendation information by using a recommendation algorithm including a CF (Collaborative Filtering) algorithm, according to an example embodiment;

FIG. 6 illustrates a method for providing recommendation information by using a recommendation algorithm including a DNN (Deep Neural Network) algorithm, according to an example embodiment;

FIG. 7 illustrates a configuration of an AI recommendation model of a computer system used to provide recommendation information, according to an example embodiment;

FIG. 8 illustrates a method for generating learning data for learning an AI recommendation model, according to an example embodiment; and

FIGS. 9A and 9B illustrate metadata of a data set that is queryable through a data catalog, according to an example embodiment.

### DETAILED DESCRIPTION

Hereinafter, embodiments of the disclosure are described in detail with reference to the accompanying drawings.

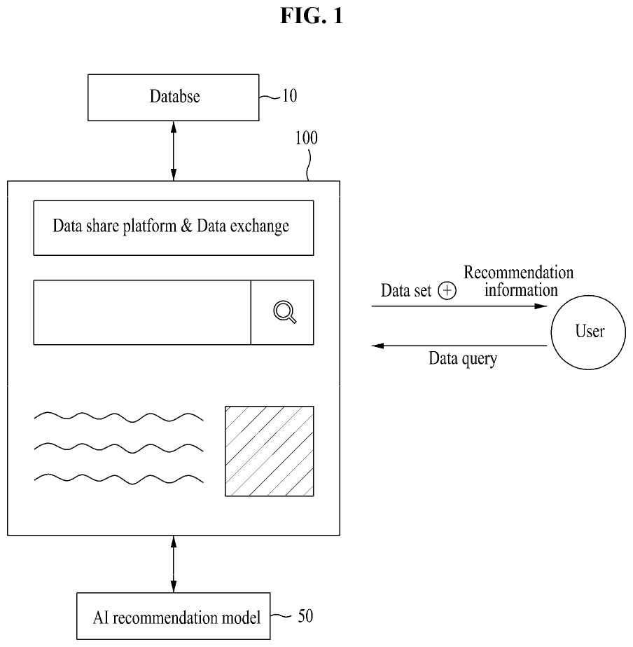

FIG. 1 illustrates a method for providing recommendation information for a user using a data catalog by using an AI recommendation model, according to an example embodiment.

Referring to FIG. 1, a method for providing a data catalog 100 is described. The data catalog 100 is provided by a computer system, and may be configured to provide function(s) related to management and retrieval of data sets stored in a database 10.

For example, the data catalog 100 may be part of a data exchange for distributing and trading pre-established data sets, or may be a function provided by the data exchange. That is, the data catalog 100 may be implemented as part of a platform on which the data exchange is built.

The data catalog 100 may provide function(s) related to management and retrieval of data sets stored in the database 10 which are subject to querying (searching, using, viewing and/or downloading) by a user. For example, as shown, the user may query a data set(s) that match a search word through entering the search word. The illustrated data catalog 100, which is as a screen of a user terminal used by such user, may be a screen of the user terminal connected to the data catalog 100.

On the other hand, the database 10 may be located within a computer system providing the data catalog 100 (and the data exchange) or may be placed separately from the computer system. One database 10 is shown, but may be plural.

The data catalog 100 may provide functions for supporting sharing of data assets for trade and distribution of data sets. Such data catalog 100 may be, for example, a tool that generate and manage a list of data sets corresponding to data assets held by an enterprise. The data catalog 100 may be used by users such as data analysts, data scientists, and the like, and may provide a function to easily query a data set that exists distributed inside or outside of an enterprise such as a data lake or cloud. The data catalog 100 may enable, for example, based on metadata related to a data set, the data set to be 1) queried (retrieved, etc.), 2) understood, 3) managed (to ensure a certain level of standards and quality), and 4) utilized un analysis and the like. In other words, the data catalog 100 may be used to maximize the availability of data.

A data set may itself have a meaning, but if a new data service is made through a chimeric analysis between the data sets, additional value may be created. Therefore, in such case, data sets may be more valuable as assets. The data catalog 100 may provide a function to intuitively and easily query a data set or a data item (data product) constituting the data set for creation of a value through such data sets. A data product may mean a data set (or a data item thereof) as a valued and distributed product. The data catalog 100 may be a catalog system which a data set (or data product) as a subject of a query. Through the data catalog 100 of the example embodiment, for a user querying a data set, recommendation information may be provided along with the result of the query (information for the data set). The recommendation information, which is related to a user or a data set queried by the user, may include information about other data sets that are of interest of the user in addition to the data set queried by the user (e.g., data sets similar to data sets queried by the user or other data sets queried by another user querying the same data sets, etc.).

Such recommendation information may be provided by using an AI (Artificial Intelligence) recommendation model 50. For example, the AI recommendation model 50 may generate recommendation information for a user by analyzing log data collected for the user and/or data sets stored in the database 10, and may provide it to the user.

The AI recommendation model 50 may be located within a computer system providing the data catalog 100 (and the data exchange) or may be located separately from the computer system. The AI recommendation model 50 may include at least one artificial neural network model. For example, the AI recommendation model 50 may include, as a deep learning model, a CNN-based model or a DNN-based model.

In using the AI recommendation model 50, the data catalog 100 may be named an AI-based data catalog.

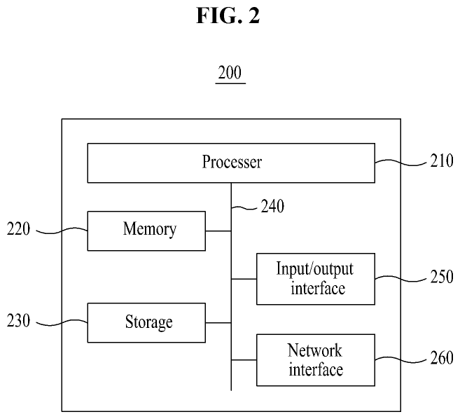

The generation and provision of specific recommendation information by the AI recommendation model 50 will be described in more detail with reference to FIGS. 2 to 8 which will be described later.

Meanwhile, in the following, a data set (or data product) queried through the data catalog 100 will be described in more detail.

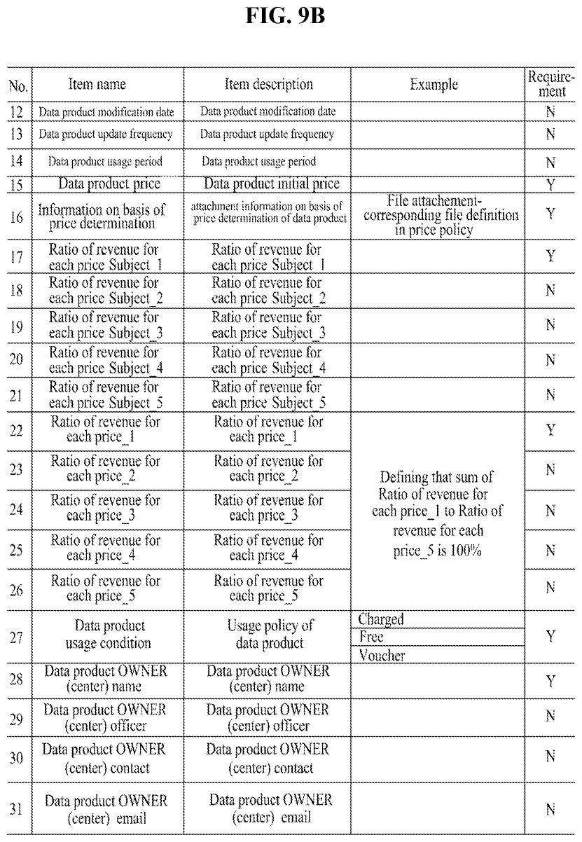

In this regard, FIGS. 9A and 9B illustrate metadata of a data set that is queryable through a data catalog, according to an example embodiment.

In order to construct the data catalog 100 of an example embodiment, a data trade/distribution metadata system describing a data set (or a data product) have to be defined in the data catalog 100. Such metadata system may apply, for example, international standards for retrieving between data catalogs and ensuring interoperability. The international standards may be, for example, DCAT (Data Catalog Vocabulary).

As shown in FIGS. 9A and 9B, the metadata required for trade and distribution of the data set may be defined as 31 upper items and their lower items, illustrated. Alternatively, the metadata items may be defined with five of data set information, data set detail, data set category, data set detail information, and data service detail information, as being defined with reference to Catalog, Dataset, Distribution, DataService structures of the DCAT.

The above described recommendation information may include information about an item of the recommended data set. The data catalog 100 may recommend not only another data set, to the user who queries a data set, but also each item of the corresponding another data set (or the other data set).

FIG. 2 illustrates a computer system for providing a data catalog for providing recommendation information by using an AI recommendation model, according to an example embodiment.

As shown in FIG. 2, a computer system 200 may include a processor 210, a memory 220, a storage 230, a bus 240, an input/output interface 250, and a network interface 260 as components for providing the data catalog 100 and executing a method for providing recommendation information through the data catalog 100. The computer system may be configured with a plurality of computer systems other than those shown. The computer system 200 may be, for example, a server or other computer for managing data sets, used in an enterprise or organization or its affiliate or head office managing and utilizing data sets (maintained in the data base 10).

The processor 210 may include or be part of any device which may process a sequence of instructions for implementing a method for providing the data catalog 100 and providing recommendation information through the data catalog 100. The processor 210 may include, for example, a computer processor, a processor in a mobile device or other electronic device, and/or a digital processor. The processor 210 may be included, for example, in a server computing device, a server computer, a series of server computers, a server farm, a cloud computer, a content platform, etc. The processor 210 may be connected to the memory through the bus 240.

The memory 220 may include volatile memory, persistent, virtual, or other memory for storing information used by or output by the computer system 200. The memory 200 may include, for example, random access memory (RAM) and/or dynamic RAM (DRAM). The memory 220 may be used to store any information such as stat information of the computer system 200. The memory 220 may also be used to store, for example, instructions of the computer system 200 including instructions for performing a method for providing the data catalog 100 and providing recommendation information through the data catalog 100. The computer system 200 may include one or more processors 210 as needed or appropriate.

The bus 240 may include communication infrastructure to enable interaction between various components of the computer system 200. The bus 240 may carry data between components of the computer system 200, for example, between the processor 210 and the memory 220. The bus 240 may include wireless and/or wired communication media between components of the computer system 200, and may include parallel, serial or other topological arrangements.

The storage 230 may include components such as memory or other storages as used by the computer system 200 to store data (e.g., compared to the memory 220). The storage 230 may include non-volatile main memory as used by the processor 210 in the computer system 200. The storage 230 may include, for example, flash memory, hard disk, optical disk, or other computer readable media.

The above described AI recommendation model 50 may be implemented in the memory 220 or the storage 230. Alternatively, such AI recommendation model 50 may be implemented on another computer system external to the computer system 200.

The input/output interface 250 may include interfaces for a keyboard, mouse, voice instruction input, display, or other input or output device.

The network interface 260 may include one or more interfaces for networks such as a local area network or the Internet. The network interface 260 may include interfaces for wired or wireless connections.

Also, the computer system 200 according to other example embodiments may include more components than the components of FIG. 2. However, it is not necessary to clearly illustrate most prior art components. For example, the computer system 200 may be implemented to include at least some of input/output devices connected with the above described input/output interfaces 250 or may further include other components such as a transceiver, a GPS (Global Positioning System) module, a camera, various sensors, a database, and the like.

Through example embodiments implemented through such computer system 200, the data catalog 100 providing functions of query and management for data sets may be provided, and recommendation information may be provided through the data catalog 100.

The description for the technical features described above with reference to FIGS. 1 to 9 may be applied to FIG. 2 as it is, so redundant description is omitted.

In the detailed description that follows, operations performed by the configuration of the computer system 200 (e.g., the processor 210) may be described as operations performed by the computer system 200, for convenience of description.

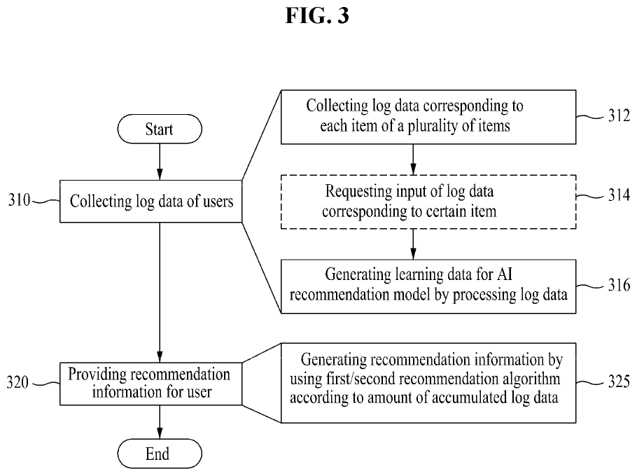

FIG. 3 is a flowchart illustrating a data catalog providing method for providing recommendation information by using an AI recommendation model, according to an example embodiment.

In Step 310, the computer system 200 may collect log data of users querying at least some of data sets (maintained in the database 10) by using the data catalog 100. The collected log data may be used to learn (train) the AI recommendation model 50 for providing recommendation information. In other words, the AI recommendation model 50 may be learned based on the log data collected from the users using the data catalog 100.

The log data may be data representing the user's behavior history in the user querying the data set through the data catalog 100. For example, the log data may include information about a data set queried by a user through the data catalog 100 and information about the user itself (identification information and the like).

The collection of the log data may occurs when a user queries a data set through the data catalog 100 (e.g., when entering a search word for querying the data set).

In the following, referring to Steps 312 to 316, a method for collecting log data of users will be described in more detail. Each of the users may be a user who has queried (or retrieved, used, viewed, or downloaded) the data set through the data catalog 100.

In Step 312, the computer system 200 may collect log data corresponding to each item of a plurality of items as log data of the user(s).

In Step 316, the computer system 200 may generate learning data for learning the AI recommendation model 50 by processing the collected log data corresponding to each item.

The plurality of items configuring the collected log data may include at least one of a first item representing a user ID of the user, a second item representing a user group in which the user is included, a third item representing a group of the data set queried by the user, a fourth item representing attribute or description of the data set queried by the user, a fifth item representing invoice information generated as the user queries the data set, a sixth item representing time when the invoice information is generated, a seventh item representing a code corresponding to the data set queried by the user, and an eighth item representing a registrant registering the data set queried by the user. Alternatively, the plurality of items configuring the log data may include at least two or all of the first to eighth items.

The learning data for learning the AI recommendation model 50 generated in Step 316 may further include log data of additional items in addition to the above described first to eighth items. The above described first to eighth items may be defined as follows. Each of the first to eighth items may be define differently depending on an organization (company and the like) in which the user is included.

Each of the first to eighth items may be defined, for example, as follows.

First item: A user ID, a user ID is as identification information for knowing which user approached which data set, the user ID may have a unique value for each user.

Second item: A user group, the second item may include identification information indicating which group the user is included in. For example, the user group may include identification information representing an enterprise or company in which the user included, or identification information representing belonging of the user within the enterprise or company (finance/HR/laboratory and the like).

Third item: A data set group (item), the third item may include identification information representing a group in which a data set queried by a user is included. For example, the third item may represent a category of a field in which the data set is included (e.g. business related data, demographic related data, etc.) or a subcategory further subdividing the category.

Fourth item: Attribute/description, the fourth item may include description/attribute information for a data set representing which data set it is and description/attribute information for components of the corresponding data set by considering that with only (article) code representing the data set queried by the user, it cannot confirm what it is.

Fifth item: Invoice information (number), the invoice information that the fifth information includes may be information included in a document (invoice) that main content is created upon a trade (or query) for a data set. The invoice information may record information about the data set queried by the user with one use of the data catalog 100 (i.e., one data set query and/or login). The invoice information may be accumulated in chronological order (in integer numbers) according to the user's activity in the data catalog 100.

Sixth item: Invoice time, the invoice time that the sixth item includes may storing the time at which the invoice in the fifth item occurred (i.e., the time when the invoice information was generated) along with the user ID as a log.

Seventh item: A data set code, the data set code that the seventh item includes may be a code for identifying what each data set is. That is, each data set may be assigned a unique code. On the other hand, the seventh item may include a code for identifying log data of a user instead of a code for identifying a data set queried by the user.

Eighth item: A registrant, the seventh item may include an ID or name of the person who registers a data set. On the other hand, the eighth item may include information about a registrant registering log data of a user (i.e., when the user and the registrant are different) instead of information for a registrant of a data set queried by a user.

Meanwhile, the aforementioned ‘group’ may be used as a term covering ‘category’.

As described above, the log data corresponding to the first to eighth items may configure the learning data required to learn the AI recommendation model 50. The data catalog 100 may be configured to obtain the log data corresponding to above described first to eighth items, according to activity form the user.

The computer system 200 may generate learning data (data set) for learning the AI recommendation model 50 by aggregating log data corresponding to the first to eighth items.

Meanwhile, in some cases, there may be cases where log data corresponding to a certain item (i.e., a specific item) of the plurality of items may not be collected. At this time, the computer system 200 may request input of log data corresponding to a certain item (which may not be collected) to a user (a user terminal of the user), as in Step 314. Or, the computer system 200 may request consent for collecting log data corresponding to a certain item (which may not be collected) to a user (a user terminal of the user), as in Step 314.

According to the data input from the user or the consent for collecting the data, the computer system 200 may complete the collection of the log data in Step 310.

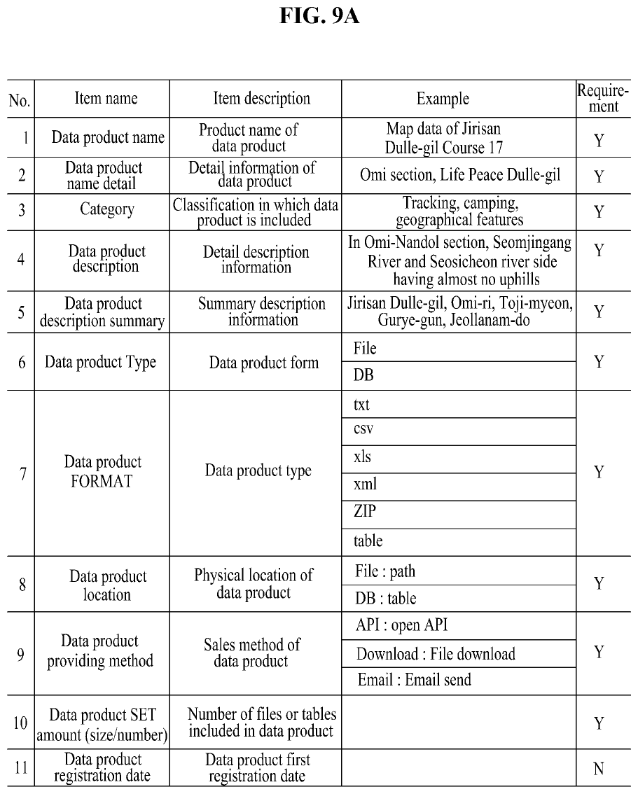

In the following, referring to FIG. 8, a method for generating learning data for learning the AI recommendation model 50 will be described in more detail.

FIG. 8 illustrates a method for generating learning data for learning an AI recommendation model, according to an example embodiment.

The data catalog 100 may provide a search engine for a big data portal or a data distribution portal of a data exchange. The computer system 200 may store history information of a data set (data product) queried by a user through the data catalog 100 as log data (corresponding to the above described log data). Metadata of the (queried) data set (data product) may be stored in a data trade distribution metadata repository (e.g., the database 10 or another database) of the computer system 200. The metadata of the data set (data product) related to a keyword retrieved by the user for querying the data set may be extracted from such repository, and a data set for learning the AI recommendation model 50 (i.e., learning data set) may be generated. For example, when a keyword, ‘customer’, is input through a search bar of the data catalog 100 to perform retrieval for a data set, information about a data set (data product) including ‘% customer %’ may be extracted from the data trade distribution metadata repository (e.g., ‘churn customer.csv’, ‘repeat customer.csv’, etc.). Such extracted information may include an ID of a data set, information of a user ID, and the like, the computer system 200 may generate learning data by obtaining attribute of data required for learning of the AI recommendation model 50 from the extracted information.

The data logs collected according to the user's activity in the data catalog 100 may differ in their nomenclature and method for accumulating log data according to a company/enterprise/organization in which a user included. In other words, when the data catalog 100 is applied to a company/enterprise/organization, the accumulated log data may be different according to the company/enterprise/organization, so such log data may be appropriately processed as data for learning the AI recommendation model 50 for the data catalog 100.

A shown in FIG. 8, various log data handled by each company, such as (data) product information, product details, product categories, product detail information, data service detail information, and the like, may be stored as needed. Such log data may include data including a (data) product ID, a product name, product information, a registrant, a registration date, a modifier, a modification date, a product usage condition, a product subtitle, a data product summary, price information, start date of usage, end date of usage, data provision, and the like, and various log data may be stored as set by the company. Such various log data may be collected according to user's activities in the data catalog 100.

The computer system 200 may appropriately process such various log data as data for learning the AI recommendation model 50 for the data catalog 100 of the example embodiments. In other words, as shown, the computer system 200 may obtain log data corresponding to the above described first to eighth items by selecting various log data stored as set by the company, and may generate learning data for learning the AI recommendation model 50 by processing (aggregating) the log data corresponding to the first to eighth items.

In Step 320, the computer system 200 may provide recommendation information for a user querying at least some of data sets by using the data catalog 100, through the AI recommendation model 50, based on at least one of log data and data sets. In other words, the computer system 200 may generate recommendation information for a user querying a data set by using the data catalog 100 through the AI recommendation model 50, and may provide the generated recommendation information to the user.

The recommendation information provided to the user may include information about a data set different from the data set queried by the user of data sets (maintained in the database 10). For example, as information about another data set, it may include information about another data set queried by another user who queried the data set queried by the user by using the data catalog 100. In other words, the user may confirm that which data set (or which item of which data set) is queried by another user who queried the data set that the user queried through recommendation information. Or, the recommendation information may information about an item of a corresponding data set queried by another user querying the same data set, in association with the data set queried by the user. Or, the recommendation information may include information about a data set of the same or similar category with the data set queried by the user (or information about a data set with a high frequency of query of another user of the data sets of the same or similar category).

The recommendation information may be displayed along with a result of a query for a data set in a screen in which the data catalog 100 of a user terminal of a user is executed.

As in Step 325, the computer system 200 may generate recommendation information by using a different recommendation algorithm according to an amount of accumulated (cumulated) log data with respect to users using the data catalog 100.

For example, the computer system 200 may use a first recommendation algorithm of the AI recommendation model 50 when there is no collected log data or the amount of the collected log data is less than or equal to a predetermined amount, and may thus generate first recommendation information. On the other hand, the computer system 200 may use a second recommendation algorithm of the AI recommendation model 50 different from the first recommendation algorithm when the amount of the collected log data exceeds the predetermined amount, and may thus generate second recommendation information.

Meanwhile, the first recommendation algorithm and the second recommendation algorithm may be implemented by each different AI recommendation mode.

According to an example embodiment, the AI recommendation model 50 providing recommendation information may generate recommendation information for a user by using a different recommendation algorithm according to the amount of the accumulated log data related to users using the data catalog 100. Therefore, the AI recommendation model 50 may provide appropriate recommendation information for a user even if there is no accumulated log data or a small amount thereof.

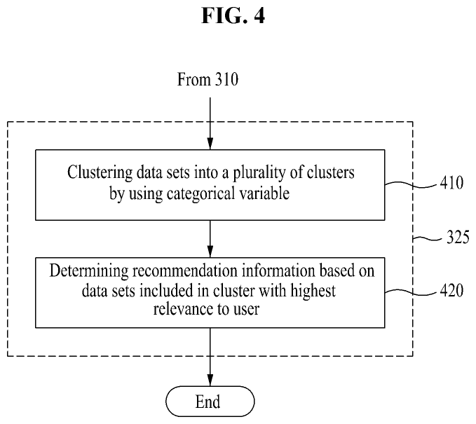

A method for generating and providing specific recommendation information based on the first recommendation algorithm and the second recommendation algorithm will be described in more detail with reference to FIGS. 4 to 7 described below.

In this regard, FIG. 4 illustrates a method for providing recommendation information by using a recommendation algorithm including a K prototype algorithm.

The above described first recommendation algorithm may include a recommendation algorithm using a K prototype algorithm.

In Step 410, the computer system 200 may cluster data sets (maintained in the database 10) into a plurality of clusters by using a predetermined categorical variable, by applying such K prototype algorithm.

In Step 420, the computer system 200 may determine data sets included in the first recommendation information, based on data sets included in a cluster with the highest relevance to a user of the plurality of clusters. The determined data sets may be data sets to be recommendation subjects, and thus information about such determined data sets may be recommendation information.

The categorical variable used for clustering the data sets in Step 410 may include at least one of a variable representing a group in which a user (querying a data set) is included (or, a group for classifying the user) and a variable representing a group in which the data set queried the corresponding user is included (or, a group for classifying the data set).

In determining data sets to be recommendation subjects in Step 520, the computer system 200 may determine that a predetermined number of data sets having higher frequency of query (of users) through the data catalog 100 of the data sets included in the cluster with the highest relevance to a user are included in the first recommendation information. Alternatively, the computer system 200 may determine that a predetermined number of data sets queried in the past by users having higher frequency of query for the data sets included in the cluster with the highest relevance to the user are included in the first recommendation information.

i) Thu cluster with the highest relevance to the user may be a cluster in which data sets included in a group that most matches a group of a data set queried by the user are included. Or, ii) the cluster with the highest relevance to the user may be a cluster in which data sets queried by users in a group that most matches a group of the user. Or, it may be data sets included in the cluster determined according to the combination of i) and ii).

As described above, the first recommendation information, may include, for example, data sets having a higher frequency of query by other users of data sets in the same/similar category as the data set queried by the user, or data sets queried by other users having a higher frequency of query for data sets in the same/similar category as the data set queried by the user.

The aforementioned ‘group’ may represent a category in which a user or a data set included, or may represent separate criteria for grouping users or data sets into a plurality of clusters.

In the following, a method for providing recommendation information by using a K prototype algorithm will be described in more detail. The method for providing recommendation information by using the K prototype algorithm may be used to provide recommendation information to a user when there is no or less accumulated log data.

The K prototype algorithm may be a technique using K modes and k means together when both Numerical and Categorical values (the above described categorical variable) exist. The clustering of data sets through the K prototype algorithm may be performed according to the following process.

1. K initial prototypes may be selected from data sets. One prototype may be selected for each cluster. The prototype may be determined based on the above described categorical variable.

2. Each subject (each data set) of data sets may be assigned to the cluster where the prototype is closest. This assignment may be performed by considering dissimilarity measure. The dissimilarity measure, which measures a numerical measure for difference between two data sets, may be lower value when both are more similar. The minimum dissimilarity measure may be 0, and its upper limit may be variously determined. Accordingly, similarity and dissimilarity between data sets may be identified.

3. Once all data sets are assigned to the cluster, the similarity for the prototype may be tested again. At this time, when a data set closest to the prototype of the cluster is found, the corresponding cluster and the prototype of the cluster in which the data set is included may be updated.

4. The process 3 may be repeated until no change of the cluster occurs for the data set included in the cluster.

In case of the K prototype algorithm, data sets may be clustered by considering the categorical variable, compared to the K means algorithm.

As described above, as the categorical variable, the group in which the user is included or the group the data set is included may be used. In other words, the computer system 200 may cluster data sets by using a categorical variable corresponding to the group in which the user is included or may cluster data sets by using a categorical variable corresponding to the group in which the data set is included.

When clustering by using the categorical variable corresponding to the group in which the user is included, data sets included in a cluster with the highest relevance to a user of the clusters clustered according to the K prototypes in which such categorical variable is considered may be determined as recommendation information. At this time, all data sets included in the corresponding cluster may be recommended, or data sets such as the top 50 or 100 data sets with the highest frequency (e.g., frequency of query by users) may be recommended. The number of recommendations may be changed depending on the preferences of setting of the user.

When clustering by using the categorical variable corresponding to the group in which the data set is included, data sets included in a cluster with the highest relevance to a user of the clusters clustered according to the K prototypes in which such categorical variable is considered may be determined as recommendation information. For example, the computer system 200 may confirm data sets queried by corresponding users by analyzing (behavior) history of top 5 users with high frequency (e.g. query frequency) for corresponding data sets, for the data sets included in the cluster in which data sets closest the group of the data set queried by the user, and information for the data sets may be provided as recommendation information. Information about the provided data sets may be provided anonymously. Thus, personal information of the user may be protected, and only information about the data set (i.e. purchased data product) queried by the user may be exposed.

In the following, a method for providing recommendation information using the second recommendation algorithm will be described in more detail.

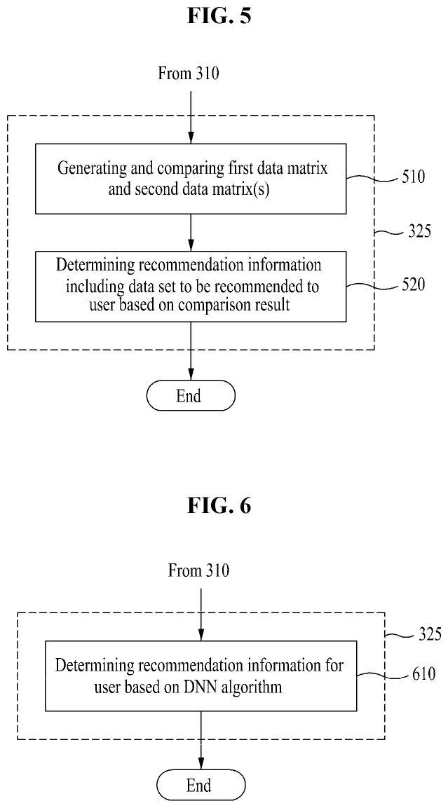

FIG. 5 illustrates a method for providing recommendation information by using a recommendation algorithm including a CF (Collaborative Filtering) algorithm.

The above described second recommendation algorithm may include a recommendation algorithm using the CF algorithm.

In Step 510, the computer system 200 may generate, by applying the CF algorithm, a first data matrix corresponding to data sets queried by a user and second data matrix(s) corresponding to data sets queried by at least one other user, and may compare the generate first data matrix and second data matrix(s). Each data set (or identification information thereof) may correspond to one element of the data matrix.

In Step 520, the computer system 200 may determine a data set to be recommended to a user as a data set to be included in the second recommendation information, based on the result of comparison in Step 510. The data set to be recommended to the user may correspond to at least some of data sets included in the second data matrix(s). At this time, the second recommendation information may not include a data set queried in the past by the user. That is, the data set queried in the past by the user may be excluded from the recommendation through the second recommendation information.

On the other hand, another user related to the second data matrix generated in Step 510 may be a user determined as a similar user for the user to which the recommendation information is provided, among users using the data catalog 100. For example, the another user may be a similar user for the user determined based on a rating vector for dividing users using the data catalog 100 into a predetermined rating. The predetermined rating may be plural, and there may be rating vector corresponding to each rating. The similar user may be, for example a user included in the same or similar group as the user.

That is, data sets queried by the similar user for the user may be the comparison subject above described.

Meanwhile, data sets included in the second data matrix, which are the comparison subjects with the first data matrix, may be data sets determined to be similar to data sets queried by the user (i.e., data sets included in the first data matrix), based on an evaluation vector representing an evaluation for data sets obtained from users using the data catalog 100. The similar data set may be, for example, a data set included in the same or similar group as the data set queried by the user. Or, similarity may be determined according to a similarity determining method described later.

That is, data sets similar to the data sets queried by the user may be the comparison subjects above described.

In the following, a method for providing recommendation information by using the CF algorithm will be described in more detail.

The CF algorithm may generate matrix for an item (i.e., a data set) and analyze correlation between items.

The computer system 200 may recommend a data set by using correlation of the data set.

The CF algorithm may be operated in a method for retrieving many users and finding a few users with a similar preference to a particular user. That is, after confirming items preferred by the user, a recommendation list may be generated and provided after the comparison and combination tasks.

The CF algorithm, which recommends a data set based on relation between items (data sets), may correspond to a recommendation algorithm based on correlation of the data set itself.

First, a matrix per data for data sets (corresponding to the above described data matrix) may be generated. This represents users querying the data set in a matrix, and the matrix may correspond to the comparison subject. According to such comparison, similarity of both matrixes may be measured. Accordingly, the data set(s) with (most) the high similarity (or higher similarity) to the user's query may be recommended.

For example, the similarity between two populations may be measured by dividing the number of users that are the intersection between two user populations (a list of users purchasing data set X and a list of users purchasing data Y) by the number of users corresponding to the union.

In the similarity calculation, when the ratio between the intersection and the union is used, the popularity and frequency of the comparison data may be ignored, or, it may apply additional weights. For example, the union is ignored, and additional weights may be applied to the intersection. This may be customized upon setting or request by the computer system 200 or a user. In the recommendation, a data set already queried may be excluded from the recommendation.

Meanwhile, as the method for measuring similarity, a method such as Cosine Similarity, Euclidean Distance score, and the like may be applied.

In addition, in the case of the CF algorithm, a user based condition may be considered, or an item based condition may be further considered.

When considering the user based condition, a similar user set with the user may be determined based on the rating vector for dividing users using the catalog 100 into the predefined rating (item rating). A rating for a user for which a rating is not determined may be determined based on selecting N (similar) users from a list of users for which ratings are determined. In other words, the rating of the user for which the rating is not specified may be calculated based the rating of N users.

For example, the CF algorithm may be applied to the users corresponding to users similar to the user and the similar user.

When considering the item based condition, the data sets may be divided into a set of similar data sets based on the evaluation vector configured with evaluations from users using the data catalog 100. At this time, an evaluation of a user who is not evaluated may be calculated from N evaluations for (similar) data sets evaluated by the user.

For example, the CF algorithm may be applied for data sets similar to the data set queried by the user.

Meanwhile, the more evaluations from the users, the higher the accuracy of the recommendation information.

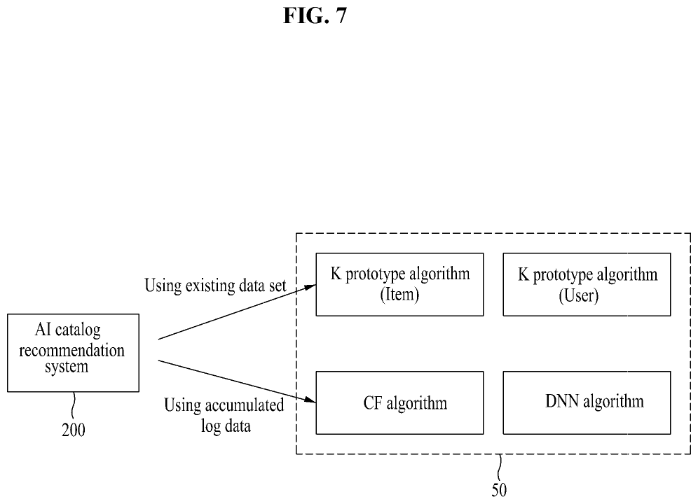

FIG. 6 illustrates a method for providing recommendation information by using a recommendation algorithm including a DNN (Deep Neural Network) algorithm, according to an example embodiment.

The above described second recommendation algorithm may further include a recommendation algorithm using a DNN (Deep Neural Network) algorithm.

In Step 610, the computer system 200 may determine, by applying the DNN algorithm, a data set to be recommended to a user of data sets (stored (or maintained) in the database 10) as a data set to be included in the second recommendation information, based on time information and behavior pattern of the user.

The second recommendation information may include at least on data set determined based on the DNN algorithm and at least one data set determined based on the CF algorithm above described with reference to FIG. 5. That is, the recommendation information may include both information about the data set recommended based on the DNN algorithm and information about the data set recommended based on the CF algorithm.

As such, The DNN algorithm and the CF algorithm may be used both in the recommendation of the data set.

However, in the user's perspective, the information about the data set recommended based on the DNN algorithm and the information about the data set recommended based on the CF algorithm may not be distinguished from each other. But, according to example embodiments, it may be displayed separately.

In the following, a method for providing recommendation information by using the DNN algorithm will be displayed in more detail.

The distinction between the above described K prototype algorithm of the DNN algorithm and the CF algorithm is that the DNN algorithm may predict future usage patterns of the user based on the user's past user behavior signals (i.e. behavior history/pattern).

That is, the AI recommendation model (50) may provide long term recommendation information (e.g., recommendation considering periodic time of long term (every month, every quarter, every year, etc.)) or short term recommendation information (recommendation considering current time point (time or time period) or environmental information (weather, etc.)), based on the time information and the behavior pattern (in the data catalog 100) of the user.

The input of the DNN algorithm (i.e., the input feature) may be configured with top N usage frequency data sets (e.g. top N data sets with high query frequency of user(s)). Here, N may be vary depending on the setting and/or the number of recommended data sets by the user/computer system 200.

Also, according to the attribute or characteristic (property) of the data set and the user, features of the data set input to the DNN algorithm may be added or subtracted. For example, the above described log data corresponding to the first to eighth items may be used as the input feature, but some of the first to eighth items may be excluded in considering training resources, costs, efficiency, etc. At this time, after the AI recommendation model 50 using the DNN algorithm is trained with the remaining log data, a retraining operation may be performed that takes into account the feature excluded through the additional operation, and thus, the AI recommendation model 50 may be updated.

Since the DNN algorithm uses time information (time) as a variable, a time period may be distinguished in utilizing the DNN algorithm for providing the recommendation information, However, all periods (whole period) may be used in learning the DNN algorithm without separating the period.

For example, in utilizing the DNN algorithm, a first period used for training the DNN algorithm and a second period used for evaluation may be distinguished. For example, the first period and the second period may be in a ratio of 4:1. Or, the first period and the second period may each be divided into several sub periods.

For each period, for example, the usage of a data set, the frequency of the data set, the number of invoices, and the like may be a target variable, and this may be customized according to the configuration of the AI recommendation model 50.

The AI recommendation model 50 using the DNN algorithm may be defined as a Sequential model, and may include a dense layer and a dropout layer. The number and structure of the layers may be different since the number of parameters may be added or subtracted depending on the size of the data sets (log data) used for learning. For the optimizer of the AI recommendation model 50, for example, an adam optimizer may be used, but it is not limited to. For the activation function, for example, relu, sigmoid, and the like may be used. The DNN algorithm of the example embodiments may utilize relu. The batch size of the AI recommendation model 50 may be 16, 32, 64, etc., and the epoch may be 100, 150, 200, etc. The AI recommendation model optimized through the test by the above values may be determined. Also, the AI recommendation model 50 may further include a softmax layer, and accordingly, a more optimized model may be configured in the ranking system.

As one example, when recommendation information including 5 data sets is provided to a user by the AI recommendation model 50, two may be recommended based on the DNN algorithm, and three may be recommended based on the CF algorithm. However, the recommendation information of this time may be provided so that the user may not identify the recommended data set is recommended based on which algorithm.

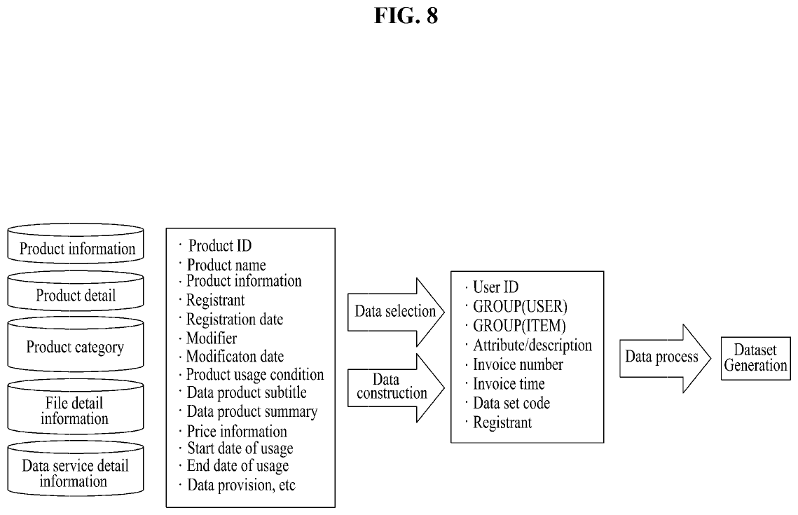

FIG. 7 illustrates a configuration of an AI recommendation model of a computer system used to provide recommendation information, according to an example embodiment.

The illustrated AI recommendation model 50 may include model(s) using the above described first recommendation model and the second recommendation model. The AI recommendation model 50, as described above, may be included in the computer system 200, or may be configured by a separate computer system from the computer system 200. In FIG. 7, the computer system 200 is named as an AI catalog recommendation system.

As shown, when the data catalog 100 is initially introduced, there is no log data for user(s) or there is a small amount of the accumulated log data, so recommendation information may be provided to the user based on data for data sets held by the computer system 200. At this time, the AI recommendation model 50 may generate and provide recommendation information by utilizing the K prototype algorithm. As shown, the K prototype algorithm may be one using a prototype based on a data set (item) (a group of data sets) or one using a prototype based on a user (a group of users).

Accordingly, until the AI recommendation model 50 is sufficiently learned (i.e., until sufficient learning data for the AI recommendation model 50 is established), the recommendation information may be generated and provided through using the K prototype algorithm based on the existing data. Also, as log data for the user is collected, the AI recommendation model 50 may be updated (customized).

When sufficient data sets (log data) for learning the AI recommendation model 50 is provided (or, when the AI recommendation model 50 is sufficiently trained by such data set (log data)), the AI recommendation model 50 may be extended to utilize the CF filtering algorithm and the DNN algorithm in generation and provision of the recommendation information.

The AI recommendation model 50 may be updated periodically or in real-time based on the collected log data. For example, the AI recommendation model 50 may be retrained at a constant period to update the above described K prototype algorithm, the CF algorithm, and the DNN algorithm, and thus may increase the accuracy of the recommendation.

In the example embodiments, at the beginning of the introduction of the AI recommendation model 50, since there is less data for users, a recommendation may be made based on the K prototype algorithm, and as the data for users is accumulated, a recommendation utilizing the CF algorithm and the DNN algorithm may be made.

Since the description for the technical features above described with reference to FIGS. 1 and 9 may be applied to directly to FIGS. 2 to 9, redundant description is omitted.

As discussed above, the data catalog 100 of the example embodiments may be used in conjunction with a data retrieval engine which is based on a data trade distribution platform. Accordingly, the data catalog 100 may provide the user with functions of metadata management, data quality management, data flow management, reference information management of the data set. To provide such functions, the computer system 200 providing the data catalog 100 may collect and store the user's experience as an analyzable form of dynamic metadata (the above described log data). In example embodiments, to provide recommendation information based on log data of the user, three recommendation algorithms may be used, and thus, the accuracy of the recommendation service may be enhanced, and the user's choice may be extended.

The service required in the platform providing the above described data catalog 100 may be provided as API, and a portal for retrieval of a data set provided through the data catalog 100 may be customized to suit the process and preferences of an enterprise or an organization.

The units described herein may be implemented using hardware components, software components, and/or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The example embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present disclosure, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. Furthermore, other examples of the medium may include an app store in which apps are distributed, a site in which various pieces of other software are supplied or distributed, and recording media and/or storage media managed in a server.

While certain example embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A data catalog providing method performed by a computer system, wherein the data catalog is configured to provide functions related to management and retrieval of data sets stored in a database,
wherein the method comprises:
collecting log data of users who query at least some of the data sets by using the data catalog; and
providing recommendation information for the users who query at least some of the data sets by using the data catalog through an AI (Artificial Intelligence) recommendation model, based on the log data and the data sets, and
wherein the AI recommendation model is learned based on the collected log data, and generates the recommendation information by using different recommendation algorithms according to an amount of the accumulated collected log data.

2. The data catalog providing method of claim 1, wherein the recommendation information comprises information about a different data set that another user who queries the data set queried by the user queries by using the data catalog, as information for the data set different from the data set queried by the user of the data sets.

3. The data catalog providing method of claim 1, wherein the collecting the log data comprises:
collecting log data corresponding to each item of a plurality of items as log data of the user; and
generating learning data for learning the AI recommendation model by processing the collected log data corresponding to each data, and
wherein the plurality of items comprises at least two of a first item representing a user ID of the user, a second item representing a user group in which the user is included, a third item representing a group of the data set queried by the user, a fourth item representing attribute or description of the data set queried by the user, a fifth item representing invoice information generated as the user queries the data set, a sixth item representing time when the invoice information is generated, a seventh item representing a code corresponding to the data set queried by the user, and an eighth item representing a registrant registering the data set queried by the user,
wherein the AI recommendation model is learned based on the learning data,
wherein the collecting the log data further comprises requesting input of log data corresponding to a certain item to the user when log data corresponding to the certain item of the plurality of items cannot be collected.

4. The data catalog providing method of claim 1, wherein the providing the recommendation information comprises:
generating first recommendation information by using a first recommendation algorithm when an amount of the collected log data is less than or equal to a predetermined amount; and
generating second recommendation information by using a second recommendation algorithm different from the first recommendation algorithm when the amount of the collected log data exceeds the predetermined amount.

5. The data catalog providing method of claim 4, wherein the first recommendation algorithm comprises a recommendation algorithm using a K prototype algorithm,
wherein the generating the first recommendation information, by applying the K prototype algorithm, comprises:
clustering the data sets into a plurality of clusters by using a categorical variable; and
determining data sets included in the first recommendation information, based on data sets included in a cluster with the highest relevance to the user of the plurality of clusters, and
wherein the categorical variable is at least one of a variable representing a group in which the user is included and a variable representing a group in which the data set queried by the user is included.

6. The data catalog providing method of claim 5, wherein the determining determines that a predetermined number of data sets having a higher frequency of query through the data catalog of the data sets included in the cluster with the highest relevance to the user are included in the first recommendation information, or determines that a predetermined number of data sets queried in the past by users having a higher frequency of query the data sets included in the cluster with the highest relevance to the users are included in the first recommendation information.

7. The data catalog providing method of claim 4, wherein the second recommendation algorithm comprises a recommendation algorithm using a CF (Collaborative Filtering) algorithm,
wherein the generating the second recommendation information, by applying the CF algorithm, comprises:
comparing a first data matrix corresponding to data sets queried by the user and a second data matrix corresponding to data sets queried by at least one other user; and
determining a data set to be recommended to the user as a data set included in the second recommendation information, based on a result of the comparison, and
wherein the data set queried in the past by the user is excluded from the recommendation through the second recommendation information.

8. The data catalog providing method of claim 7, wherein the other user is a similar user for the user determined based on a rating vector for dividing users using the data catalog into a predetermined rating.

9. The data catalog providing method of claim 7, wherein the data sets included in the second data matrix are data sets determined to be similar to data sets queried by the user, based on an evaluation vector representing an evaluation for data sets obtained from users using the data catalog.

10. The data catalog providing method of claim 7, wherein the second recommendation algorithm further comprises a recommendation algorithm using a DNN (Deep Neural Network) algorithm,
wherein the generating the second recommendation information comprises, by applying the DNN algorithm, determining a data set to be recommended to the user of data sets stored in the database as a data set included in the second recommendation information, based on time information and a behavior pattern of the user, and
wherein the second recommendation information comprises at least one data set determined based on the DNN algorithm and at least on data set determined based on the CF algorithm as a recommendation data set for the user.

11. The catalog providing method of claim 1, wherein the collecting the log data comprises:
collecting log data corresponding to each item of a plurality of items as log data of the user and
generating learning data for learning the AI recommendation model by processing the collected log data corresponding to each item,
wherein the plurality of items comprise a first item representing a user ID of the user, a second item representing a user group in which the user is included, a third item representing a group of the data set queried by the user, a fourth item representing attribute or description of the data set queried by the user, a fifth item representing invoice information generated as the user queries the data set, a sixth item representing time when the invoice information is generated, a seventh item representing a code corresponding to the data set queried by the user, and an eighth item representing a registrant registering the data set queried by the user,
wherein the AI recommendation model is learned based on the learning data,
wherein the collecting the log data further comprises:
requesting input of log data corresponding to a certain item to the user when log data corresponding to the certain item of the plurality of items cannot be collected; and
requesting consent for collecting log data corresponding to a corresponding certain item to the user when log data corresponding to the certain item of the plurality of times cannot be collected,
wherein providing the recommendation information comprises:
generating first recommendation information by using a first recommendation algorithm when an amount of the collected log data is less than or equal to a predetermined amount; and
generating second recommendation information by using a second recommendation algorithm different from the first recommendation algorithm when the amount of the collected log data exceeds the predetermined amount,
wherein the first recommendation algorithm comprises a recommendation algorithm using a K prototype algorithm,
wherein the generating the first recommendation information, by applying the K prototype algorithm, comprises:
clustering the data sets into a plurality of clusters by using a categorical variable including a variable representing a group in which the user is included; and
determining that data sets are included in the first recommendation information based on data sets included in a cluster with the highest relevance to the user of the plurality of clusters, and determining that data sets queried in the past by a predetermined number of users having a higher frequency of querying the data sets included in the cluster with the highest relevance to the users are included in the first recommendation information,
wherein the second recommendation algorithm comprises a recommendation algorithm using a CF (Collaborative Filtering) algorithm and a recommendation algorithm using a DNN (Deep Neural Network) algorithm,
wherein the CF algorithm and the DNN algorithm are used both to generate the second recommendation information in parallel,
wherein the generating the second recommendation information, by applying the CF algorithm, comprises:
comparing a first data matrix corresponding to data sets queried by the user and a second data matrix corresponding to data sets queried by at least one other user; and
determining a first data set to be recommended to the user as a data set included in the second recommendation information, based on a result of the comparison,
wherein the data sets included in the second data matrix are data sets determined to be similar to data sets queried by the user, based on an evaluation vector representing an evaluation for data sets obtained from users using the data catalog,
wherein the data set queried in the past by the user is excluded from the first data set,
wherein the other user is a similar user for the user determined based on a rating vector for dividing users using the data catalog into a predetermined rating.
wherein the generating the second recommendation information comprises, by applying the DNN algorithm, determining a data set to be recommended to the user of data sets stored in the database as a second data set included in the second recommendation information, based on time information and a behavior pattern of the user, and
wherein the second recommendation information comprises the first data set determined based on the CF algorithm and the second data set determined based on the DNN algorithm, and
wherein, in that the second recommendation information is provided to the user, the first data set and the second data set are provided to be displayed separately from each other.
